(19) United States
(12) Patent Application Publication
(10) Pub. No.: US 2008/0079808 A1
(43) Pub. Date: Apr. 3, 2008

(54) Method and device for collection and application of photographic images related to geographic location

(76) Inventors: Jeffrey Michael Ashlock, Saratoga, CA (US); Jeffery Joseph Bradford, San Jose, CA (US); Richard Noel Brown, Palo Alto, CA (US); David Brian Moore, Atherton, CA (US)

Correspondence Address: PATRICK REILLY, P.O. BOX 7218, SANTA CRUZ, CA, 95061-7218, US

(21) Appl. No.: 11/541,129

(22) Filed: Sep. 29, 2006

(51) Int. Cl. H04N 7/18

(52) U.S. Cl. 348/118

(57) ABSTRACT

A system and method for providing visual images of real property are provided. A 360-degree panoramic digital camera generates instances of photographic image data that are each recorded in a separate digital document. Each digital document further contains a location indicator of where the image data was captured. The documents may be organized into segments, wherein endpoints of each segment are associated with endpoints of other segments.

### FIELD OF THE INVENTION

The present invention relates to the field of digital photography. The present invention more particularly relates to the generation and association of digitized photographic data by means of information technology.

### BACKGROUND OF THE INVENTION

Human beings typically rely on visual input to maintain a significant sense of place and to gain information about the nature and attractiveness of a location or a real property. The photographic industry has therefore developed many innovations to consistently, easily and economically provide representations of visual images by means of hard copy photographic publication.

The more recent prior art provides for Internet distribution of photographic images. Attempts have been made to ergonomically integrate map data with photographic images by means of rendered representations of graphics, video and photographs on client systems. More recently satellite photography has been integrated with map graphics and made commercially available by firms that include Google and Yahoo. Other actors in the art, such as Microsoft, have begun to integrate photographic data representing street level views of locations associated with map data describing the locale of the photographic data.

The prior art, however, does not provide a seamless visual experience to the user. Improvements in the methods and systems for recreating a visual experience or providing visual representations can enhance user experience and lead to significant commercial advantage to the provider of the experience. There is therefore a long felt need to provide systems and methods that reduce the degradation of the user experience in the rendering of digitized representations of visual scenes to client systems via the electronic communications technology.

### OBJECTS OF THE INVENTION

It is an object of the Method of the Present Invention to enhance that quality of a user experience in viewing the rendering of images by means of information technology.

It is an optional object of the Method of the Present Invention to enable the presentation of 360-degree views of a geographic location by means of information technology.

It is an additional optional object of the Method of the Present Invention to enable the consecutive presentation of a plurality of 360-degree views of geographic positions by means of information technology, wherein each geographic position is located within 100 meters of at least one other geographic position.

It is a further optional object of the Method of the Present Invention to enable the insertion of representations of information within the visual experience of an observer of the rendering of images by means of information technology.

### SUMMARY OF INVENTION

Towards these and other objects that will be made obvious in light of the present disclosure, a first preferred embodiment of the method of the present invention provides a method for collecting photographic data, the method (a.) collecting a plurality of individual digitized 360 degree images; (b.) associating a geographic location data with each digitized image; and (c.) storing the plurality of digitized 360 degree images and associated geographic location data in an accessible data structure.

Alternatively and/or additionally a first preferred embodiment of the method of the present invention provides a device for capturing photographic images of real property that includes a 360-degree digital camera, a computational engine, and a motorized platform. The computational engine is communicatively coupled with the 360-degree digital camera and receives digitized image documents from the 360-degree digital camera.

Various alternate preferred embodiments of the method of the present invention may provide one or more additional or optional elements, such as an electronic memory, a wireless interface, a global positioning system transceiver, an inertial measurement unit, and one or more lights for illuminating a subject of a photograph or video.

Various other alternate preferred embodiments of the method of the present invention may include one or more additional or optional aspects including integrating advertising into images rendered on an information technology system, wherein the advertising may provide information concerning real estate services, real estate sales, travel, tourism, and other consumer, business and professional services.

Information related to the real estate industry may relate to market value appraisal tools and/or taxation data. Alternatively or additionally the provided information may relate to one or more addresses associated with a selected (1.) real property, (2.) real estate lot number, and/or (3.) global positioning system coordinates. Certain still other alternate preferred embodiments of the method of the present invention enable a video scan of an environ surrounding a selected real property and/or a showcasing of the selected real property.

Travel information may include route information and images of locations through which a proposed route will travel. Route information may further provide driving directions and/or two or more suggested and alternate routes and listings of business and services available along each route.

Tourism information may include video or photographic tours of recreational sites, such as golf courses, coastal scenes and forest trails.

Information related to routes of travel may further include data concerning road sports venues and facilities, parades and public safety. Certain information useful to, or derived from, video and television production and broadcasts and virtual tours are provided in certain still additional alternate preferred embodiments of the method of the present invention. Public safety information may encompass and describe parade route logistics, crime prevention data, security considerations, emergency response data, fire fighting equipment requirements and capabilities, and training information.

In certain even additional preferred embodiments of the method of the present invention the data gathered by the video camera may be integrated within computer generated game scenarios and provide backgrounds and settings for video game products and actualizations. The games scenarios may include training and educational material

Certain yet other preferred alternate preferred embodiments of the method of the present invention includes the provision of personalized, targeted and/or geospatial information, wherein the information integrated in the rendering of the visual images is selected at least partially on the basis of data associated with a user of an information technology system presenting the rendered images.

The foregoing and other objects, features and advantages will be apparent from the following description of the preferred embodiment of the invention as illustrated in the accompanying drawings.

### BRIEF DESCRIPTION OF DRAWINGS

These, and further features of the invention, may be better understood with reference to the accompanying specification and drawings depicting the preferred embodiment, in which:

FIG. 1 is a schematic diagram of a first preferred embodiment, or first system, of the present invention with optional elements;

FIG. 2 is an illustration of the first system of FIG. 1 housed within an automobile;

FIG. 3 is a schematic of an electronic communications network communicatively coupled with the first system of FIG. 1;

FIG. 4 is a flow chart of a software program executable by the first system of FIG. 1;

FIG. 5 is a flow chart of an integration of information within video data acquired by the first system of FIG. 1;

FIG. 6 is a schematic representation of an electronic document including information generated by the first system of FIG. 1 and other information integrated as per the flow chart of FIG. 4;

FIG. 7 is an entity diagram of an information technology system that provides map graphics and visual data generated by the first system of FIG. 1 in an integrated format via a guided user interface of a client system of FIG. 3;

FIG. 8 is a flowchart of an information technology system that renders the documents of FIG. 6 by means of a client system and a communications network of FIG. 3;

FIG. 9 is a flow chart of a client system that renders views of the documents of FIG. 5 and enables attitude selection in reference to a horizon plane;

FIG. 10 illustrates a street wherefrom a plurality of image data are generated by the camera of FIG. 1;

FIG. 11 is a schematic representation of a segment data structure that comprises a plurality of digital documents of FIG. 6;

FIG. 12 is an illustration of the relationship of streets to a neighborhood; and

FIG. 13 is an illustration of a street intersection.

### DETAILED DESCRIPTION OF PREFERRED EMBODIMENTS

In describing the preferred embodiments, certain terminology will be utilized for the sake of clarity. Such terminology is intended to encompass the recited embodiment, as well as all technical equivalents, which operate in a similar manner for a similar purpose to achieve a similar result. The present invention is directed to an apparatus, method, and program for rendering images by means of information technology. When discussing the invention the following terms have the means indicated. Any undefined term has their art recognized meaning.

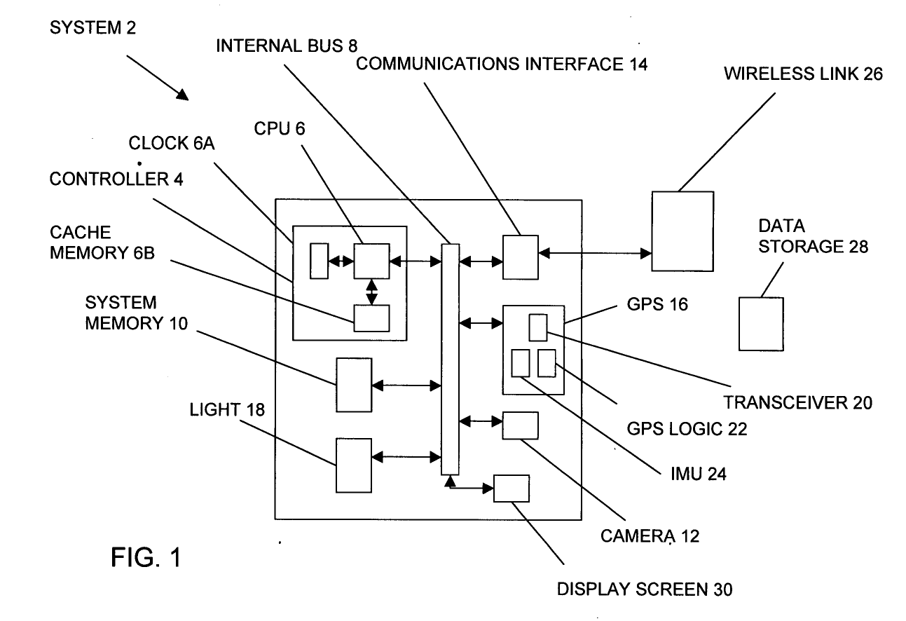

Referring now generally to the Figures, and particularly to FIG. 1, FIG. 1 is a schematic diagram of a first preferred embodiment 2, or first system 2, of the present invention with optional elements. A controller 4 includes a central processor unit 6 (hereafter “CPU” 6) comprising a real time clock 6A and a cache memory 6B. The controller 4 may be or comprise a logic processing semiconductor device, such as a PENTIUM™ microprocessor manufactured by Intel Corporation of Santa Clara, Calif. The controller 4 is bi-directionally coupled by means of an internal communications bus 8 with a system memory 10, a digital camera 12, an external communications interface 14, a global positioning system 16 (hereafter “GPS” 16) and a light module 18. The CPU 6 directs the digital camera 12 to capture images while approximately simultaneously polling the GPS 16 for GPS location data. The GPS 16 is configured with a GPS transceiver 20 that receives and processes GPS information from one or more global positioning satellites located in orbit about the Earth. The GPS 16 is further configured with a GPS logic circuit 22 to extract or derive the GPS location data from the GPS information. The CPU 6 may optionally poll an inertial measurement unit 24 for inertial measurement information used by the CPU to modify the GPS location data. Alternatively, the GPS logic 22 may modify the GPS location data prior to sending GPS location data to the CPU 6. Communication with wireless devices and transceivers is enabled by a wireless link 26 communicatively coupled with the external communications interface 14, whereby digitized photographs generated by the camera 12 may be transmitted to a remote digital data storage device 28. In addition, the digitized photographs, or documents D, generated by the digital camera 12 may visually rendered by the first system 2 and visually displayed by means of a display screen 30 communicatively coupled with the CPU 6.

The controller 4 may be or comprise (1.) a VAIO FS8900™ notebook computer marketed by Sony Corporation of America, of New York City, N.Y., (2/) other suitable prior art personal computers known in the art comprising an XP™ or VISTA™ personal computer operating system marketed by Microsoft Corporation of Redmond, Wash., and/or (c.) a POWERBOOK™ personal computer marketed by Apple Computer, Inc., of Cupertino, Calif.

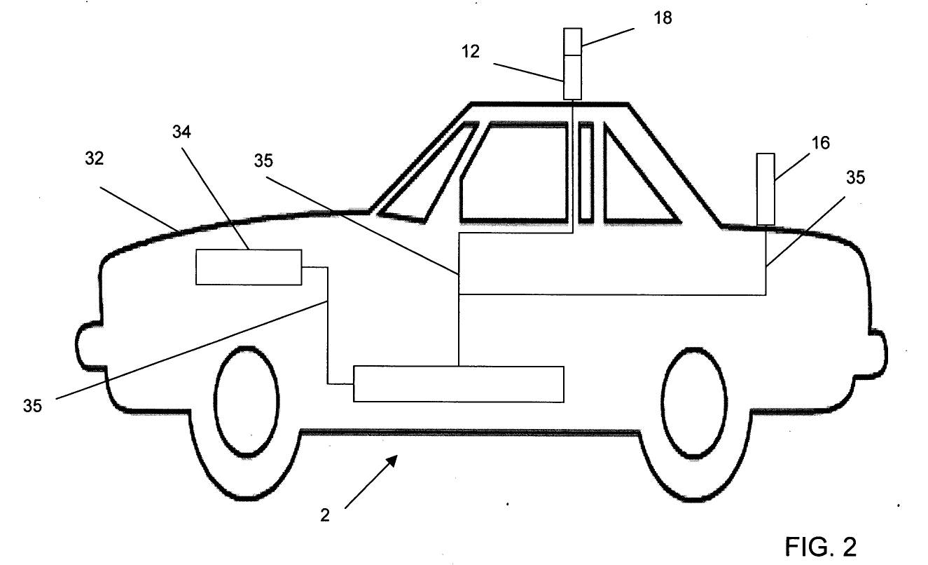

Referring now generally to the Figures, and particularly to FIG. 2, FIG. 2 is an illustration of the first system 2 of FIG. 1 housed within an automobile 32. The automobile 32 provides an electrical power source 34 that delivers electrical power to the first system 2 by means of electrical power lines 35. The electrical power source 34 may comprise a Wagan Tech™ 1250 Watt power inverter, one or more deep cycle 12 volt batteries, and/or other suitable power source components known in the art. The GPS 16 may include a Novatel SPAN PROPAK™ GPS instrument comprising a PROPAK LBPLUS™ GPS instrument, an IMU-G2™ inertial measurement unit, and a GPS-600-LB™ antenna. The camera 12 may include a OMNIALERT™ camera system marketed by RemoteReality Corporation of Westborough, Mass., and comprising (1.) a LUMENERA LE277™ network camera; (2.) a LUMENERA LE275™ network camera as modified by REMOTE REALITY; and/or (3.) a photographic lens with a parabolic mirror.

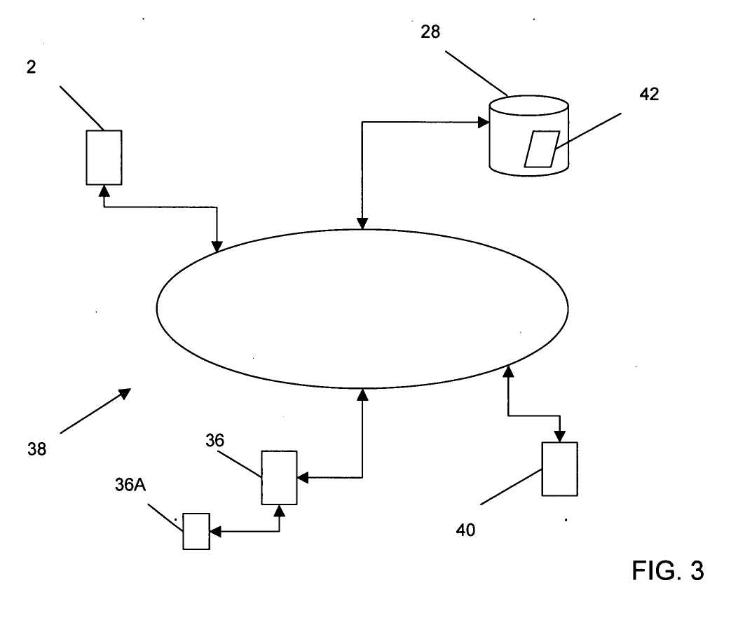

Referring now generally to the Figures and particularly to FIG. 3, FIG. 3 is a second preferred embodiment of the present invention that includes the first system 2, the digital data storage device 28, a client system 36, and an electronics communication network 38. The electronics communications network 38 bi-directionally communicatively couples the first system 2, the digital data storage device 28 and the client system 36 to enable the transfer of digital image data from the first system 2 to the digital data storage device 28 and the client system 36 for storage and optionally for presentation to a user via a video display screen. The client system 36 may be a personal computer, such as a POWERBOOK™ personal computer manufactured by Apple Computer of Cupertino, Calif. and may further be equipped with a video presentation software, such as QUICKTIME digital video data player or REAL PLAYER digital video data player. An external computer 40, configured to have the same or equivalent capabilities of the first system 2 and/or the client system 36, may be bi-directionally communicatively coupled with the electronic communications network 38, whereby users may access or modify documents D as stored in a data base 42 of the data storage device 40.

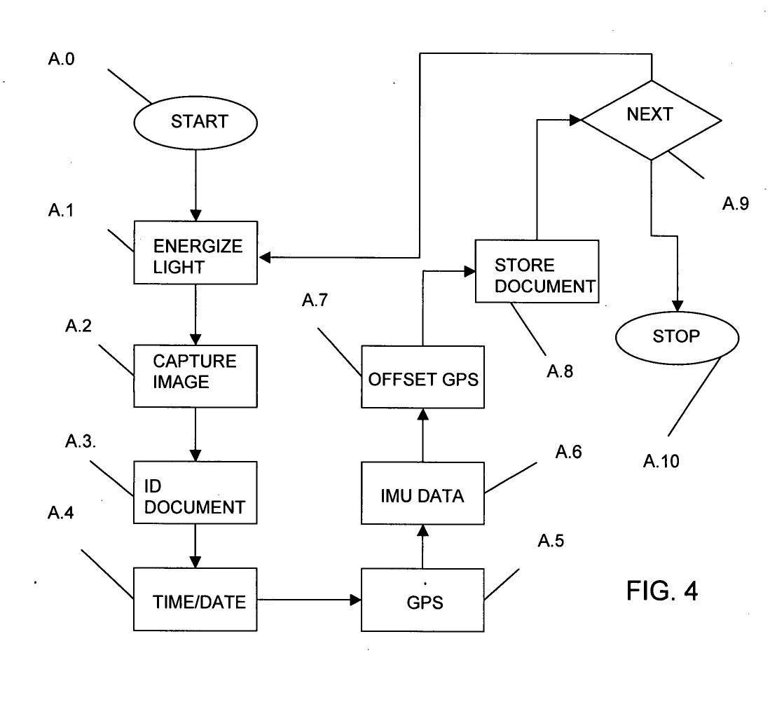

Referring now generally to the Figures, and particularly to FIG. 4, FIG. 4 is a flow chart of a software program executable by the first system 2 of FIG. 1. In step A.1 the optional light is energized. In step A.2 the digital camera 12 captures a 360-degree visual image and generates a digitized photographic image data P stored within a digital electronic document D. The image data P contains 360-degree panoramic image data. The digital electronic document D (hereafter “document” D) comprises machine-readable code for rendering image data P of the electronic document D as an image on a video display screen 30 of the first system 2 and/or the client system 36. In step A.3 the document D is generated comprising the image data P and stored in the system memory 10 and associated with a document identification number (hereafter “ID”). In step A.4 time/date stamp data D1 is added to the document D, wherein the time/data stamp data D1 is generated coincident with the generation of the image data P by the digital camera 12. In step A.5 a GPS data D2 is added to the document D, wherein the GPS data D2 identifies the geographic location of the camera 12 when the document D was generated. The GPS data D2 may further comprise a postal address information. In optional step A.6 an IMU data is generated by the IMU 24 and is read by the first system 2. In step A.7 the GPS data D2 is modified by computation on the basis of the IMU data by either the CPU 6 or the GPS logic 22 to more accurately estimate the location of the camera 12 at the time the camera 12 generated the image data P. In step A.8 the electronic document D is stored in the system memory 10 and/or transmitted via the wireless link 26 for remote storage in the data storage device 28. In step A.9 the first system 2 determines whether an additional image is to be captured by the camera 12, and, when so, to proceed on to step A.1, and otherwise to proceed on to step A.10 and to return the controller 4 to performing alternate operations.

It is understood that the documents D may be stored in a unitary storage device, such as the data storage device 28, or distributed throughout the electronic communications network 38, to include optionally the internet, and/or the client system 36 or the first system 2. It is further understood that the remote data base 42 may be a unified data base stored within a single computer 2, 38, 36, or 40, or be a distributed or federated data base that is stored in two or more locations within the first system, communications network 38, and/or one or more client systems 36, external computers 40, and/or data storage devices 28.

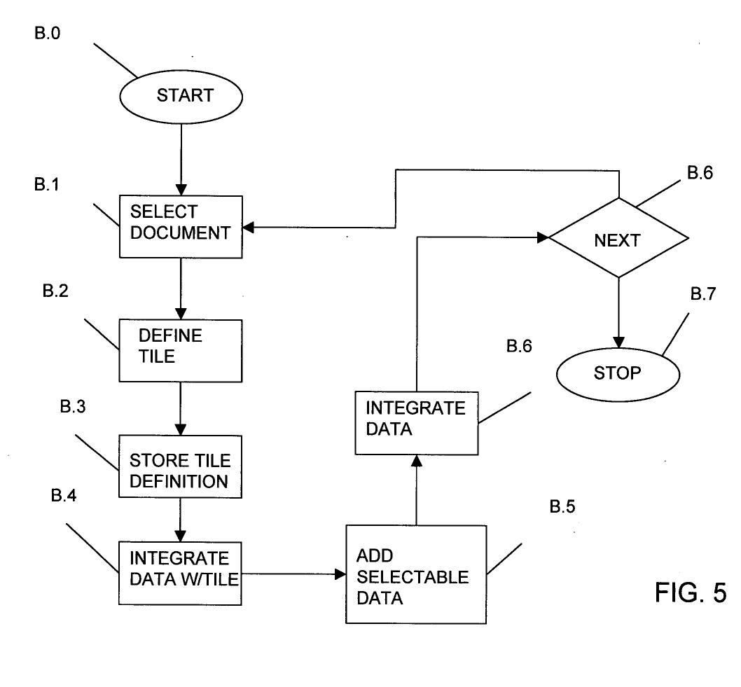

Referring now generally to the Figures, and particularly to FIG. 5, FIG. 5 is a flow chart of an integration of information within digital image data P generated by the first system 2 of FIG. 1 and is included within one or more selected documents D. In step B.1 a document D is selected from the system memory 10 or the remote storage device 28. In step B.2 a portion of the digitized image data P of the document D is identified as a tile T useful for displaying an image, icon and/or information associated within the document D. In step B.3 the memory locations D3 of the image P that comprise the tile T are stored in the document D. In Step B.4 digital data of an image, icon and/or information D4 is integrated with the tile T into the document D wherein the image icon or information D4 is overwritten onto at least some of the contents of the memory locations D3 tile T. In step B.5 additional information D5 that may optionally be accessed by a user by selecting the tile T is added into the document D, e.g., wherein the user might double click on a mouse 36A of the client system 36 to select the tile T while the image data P is being rendered on a display screen 28 of the client system 36. In step B.6 the additional information is associated with the tile T of step B.3. In step B.7 the first system 2 determines whether an additional tile T is to be integrated into the same or another document D, and,.when so, to proceed on to step B.1, and otherwise to proceed on to step B.8. It is understood that the tile information D4 and/or the additional information D5 may be an advertisement for goods or services. It is further understood that the tile information D4 and/or the additional information D5 may relate to a real estate transaction, such as an appraisal value or a sales price.

In certain other alternate preferred embodiments of the present invention the mouse 36A of the client system 36 may be or comprise a computer mouse such as (a.) a Targus™ Bluetooth capable computer mouse coupled with a AdapterspacerVS-AMB01US™ Bluetooth adapter, (b.) an Apple Mighty Mouse™ computer mouse, (c.) an Apple Wireless Mouse™ computer mouse, or (d.) other suitable computer mouse or other suitable icon selection device known in the art configured to enable a user to select an icon as presented on a visual display device 10 of the client system 36.

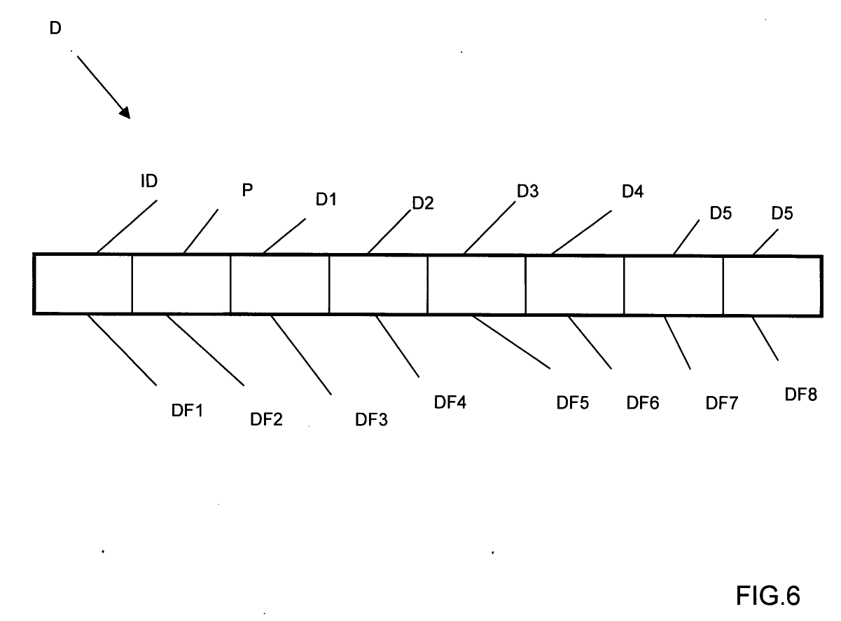

Referring now generally to the Figures, and particularly to FIG. 6, FIG. 6 is a representation of the document D having data fields DF1-DF8. The ID of the document D is stored in a first data field DF1. The image data P is stored in a second data field DF2. The time date stamp D1 is stored in a third data field DF3. The GPS data is stored in a fourth data field DF4. The tile memory locations D3 of the image data P that are comprised within the tile T are stored in a fifth data field DF5. Information D4 to be displayed in at least some of the tile memory locations D3 is stored in a sixth data field DF6. Additional information D5 that may be selectably displayed by command of the user is stored in a seventh data field DF7. An additional information D5 that may be selectably displayed by command of the user is stored in an eighth data field DF8.

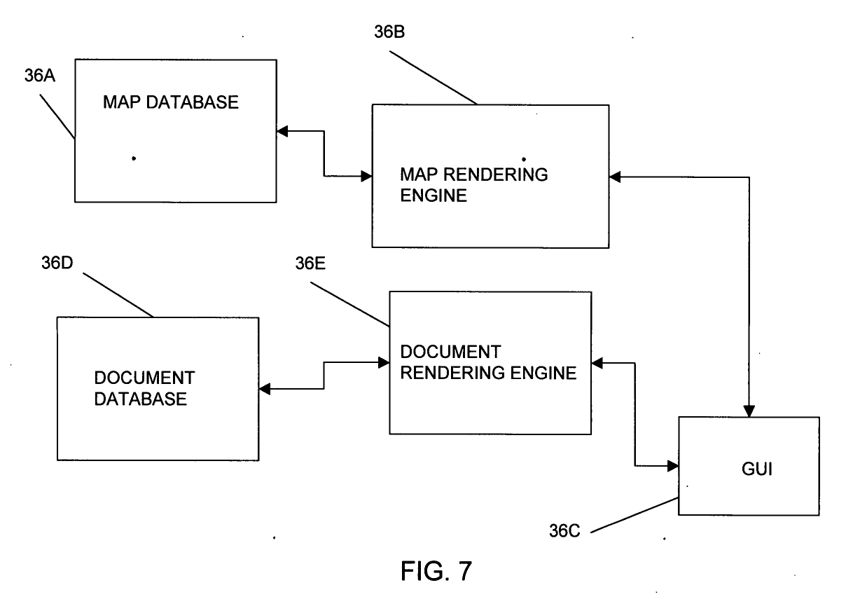

Referring now generally to the Figures, and particularly to FIG. 7, FIG. 7 is an entity diagram of the client system 36 that provides map graphics and visual data P generated by the first system 2 of FIG. 1 in an integrated format via a graphical.user interface. A map data base 36A is rendered by a map rendering engine 36B under the control of a graphical user interface 36C (hereafter “GUI” 36C). In addition, documents D stored in a document data base 36D is rendered by a visual document rendering engine 36E under direction of the GUI.

The software tools 36A-36E identified in the entity diagram of FIG. 7 may include or be comprised within a suitable operating system known in the art, to include WINDOWS™ personal computer operating system software manufactured by Microsoft Corporation of Redmond, Washington or MAC OS X™ personal computer operating system software manufactured by Apple Computer of Cupertino, Calif. The software tools 36A-36E identified in the entity diagram of FIG. 7 may include or be comprised within Adobe Photoshop™ digital image modification software; mapping software, such as Delorme Street Atlas™ map image generation software, that allows a location specified by a longitude and latitude coordinate to be plotted on the map; a database application for storing the images such as My SQL™ database software; an image viewer which is capable of displaying 360 degree panoramic images such as found in QuickTime™ digital image presentation software; and website building software that is readily available from many sources such as Adobe or Microsoft. A software. development program, such as Microsoft Visual Studio, for linking the components of the entity diagram of FIG. 6 may also be included in the creation and/or operation of the software tools 36A-36E of FIG. 7.

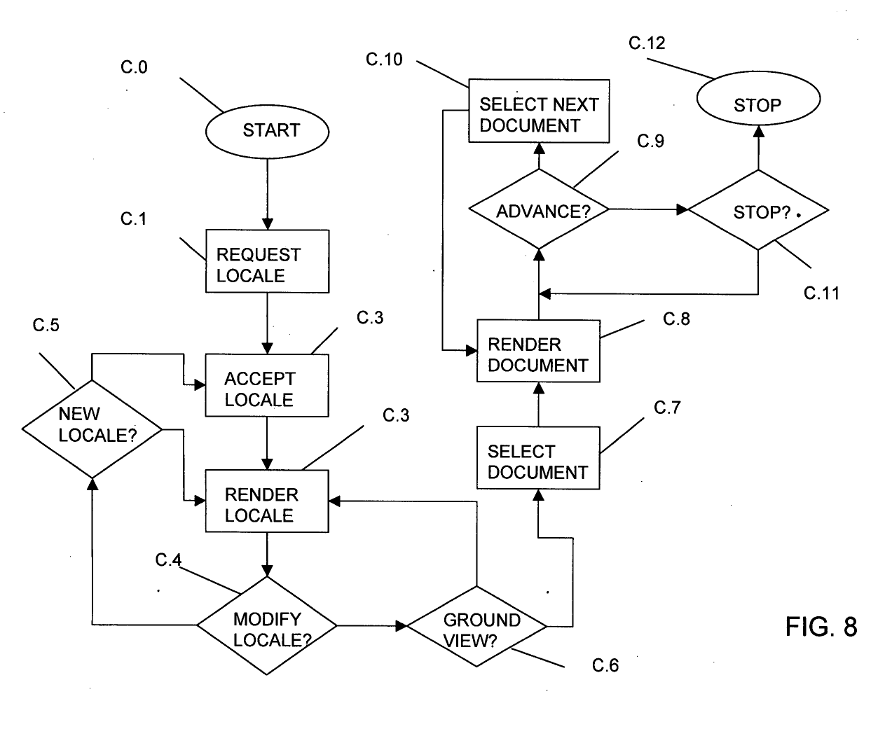

Referring now generally to the Figures, and particularly to FIG. 8, FIG. 8 is a flowchart of an operation of the client system 36 that applies the GUI 36C to control the rendering of the documents D of FIG. 5 by means of the client system 36 and the communications network 38. It is understood that the electronic communications network 38 may comprise or be comprised within the Internet.

The GUI 36C requests the user to identify a locale to be rendered from a map graphic rendered by the map rendering engine 36B in step C.1. In step C.2 the GUI 36C accepts a locale from the user and renders map data of the map database 36A related to the accepted locale via the display screen 30 of the client system 36 in step C.3. In step C.4 the GUI 36C queries the user whether the user wishes to proceed to ground viewing or to select an alternate map locale, as per step C.5. In step C.6 the user queries the user to identify a point within the map locale for viewing at a ground viewpoint. In step C.7 the GUI 36C selects a document D from the document database 36D having a GPS data D2 most proximate to the ground viewpoint indicated by the user in step C.6, and renders the visual data P from the selected document D in step C.8. In step C.9 the user may input a direction to advance towards, and in step C.10 the GUI selects the next most proximate document along the indicated direction.

In step C.11 the client system 36 determines whether an additional document D is to be rendered, or otherwise to proceed on to step C.12 and to return the client system 36 to performing alternate operations.

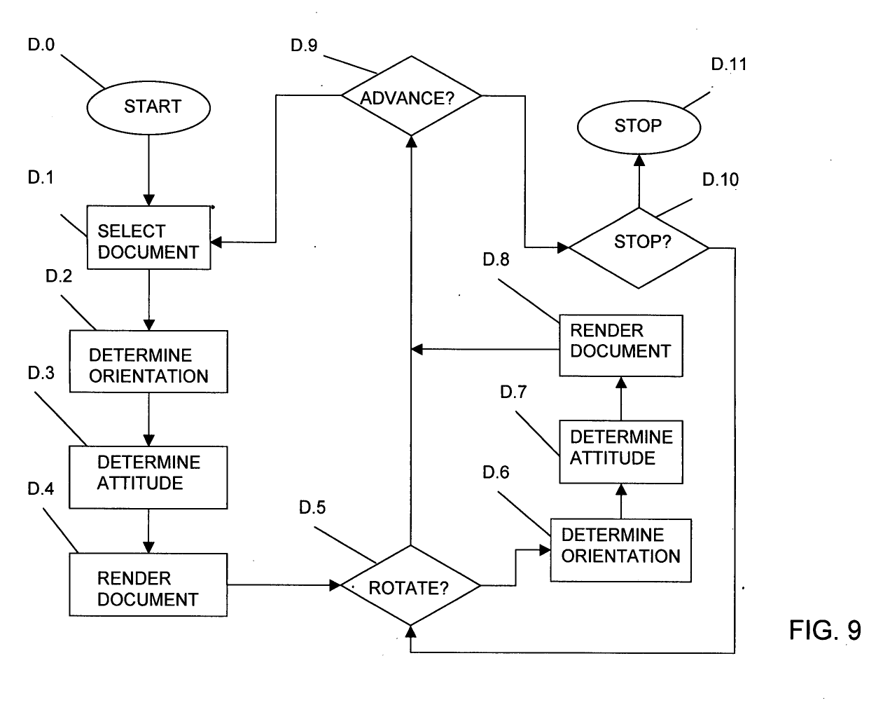

Referring now generally to the Figures, and particularly to FIG. 9, FIG. 9 is a flow chart of an operation of the client system 36 applying the GUI 36C to control the rendering of the documents D of FIG. 5 and enables attitude selection in reference to a horizontal plane. In step D.1 a document D is selected and an orientation (as per step D.2) and an attitude (as per step D.3) is determined. In step D.4 the image data P of the selected document D of step D.1 is rendered in accordance with the orientation determination of step D.2 and the attitude determination of step D.3. In step D.5 the user has the opportunity to rotate a point of view in relation to which the image data P is rendered. In step D.6 the orientation may be changed as directed by the user. In step D.7 the attitude may be changed by the user. In step D8 the image data is rendered at the client system 36 in accordance with the process of steps D.6 and D.7. In step D.9 the user may direct the GUI 36C to advance to another document D and proceed back to step D.1, or to halt the rendering process by selecting first step D.10 and then step D.11.

The software tools useful in executing various of the steps of the method of the present invention include digital image manipulation tools such as Adobe Photoshop™ digital image modification software; mapping software, such as Delorme Street Atlas™ map image generation software, that allows a location specified by a longitude and latitude coordinate to be plotted on the map; a database application for storing the images such as My SQL™ database software; an image viewer which is capable of displaying 360 degree panoramic images such as found in QuickTime™ digital image presentation software; and website building software that is readily available from many sources such as Adobe or Microsoft. A software development program, such as Microsoft Visual Studio, for linking the components of the invention may also be useful.

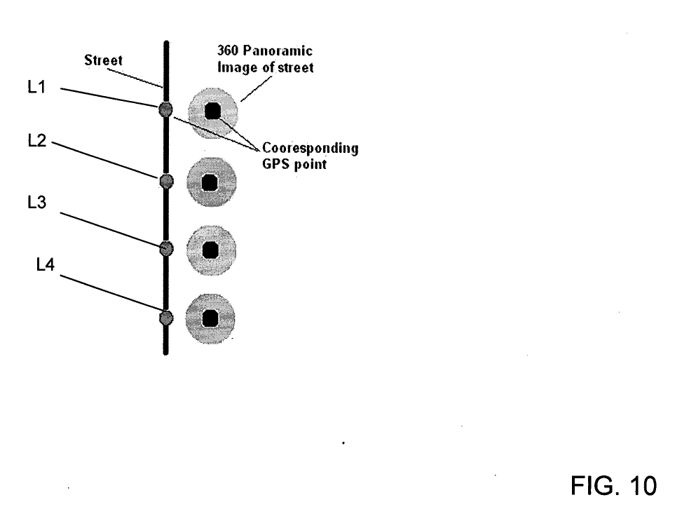

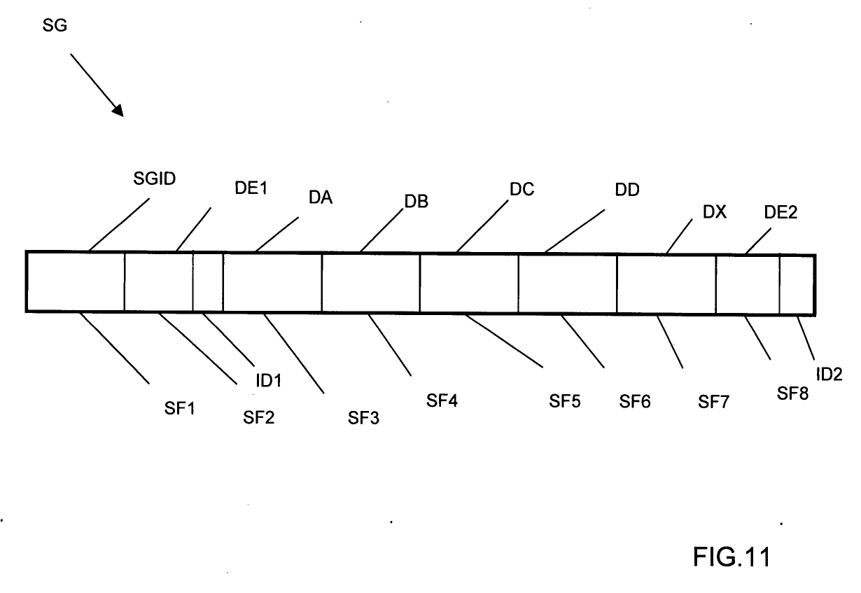

Referring now generally to the Figures and particularly to FIGS. 10 and 11, FIG. 10 illustrates a street S wherefrom a plurality of image data P are generated by the camera 12, each image data P generated at one of a plurality of locations L1-L4.

Referring now generally to the Figures and particularly to FIG. 11, a second preferred alternate preferred embodiment of the method of the present invention, or second method, allows a user connected to the electronic communications network 38 by means of the client system 36 accessing a plurality of segments SG, each segment SG comprising a plurality of documents D as generated by the first system 2 and/stored on the first system 2, a client system 36 and/or the remote digital data device 28. By using the client system 36 to sequentially present documents DE1-DE2, DA-DX the user may virtually drive a street S and be able to view, in a 360-degree panoramic view, image data P of the surroundings of certain points of the street S. A video of the street S may be rendered in accordance with the second method, from the 360 degree panoramic image data P of a plurality of documents D by displayed by a client system 36 at fast rate, e.g., sixty images P per second, to simulate actually driving down the street S.

It is understood that documents DE1-DE2, DA-DX are particular instances of the document D.

Each segment SG comprises a plurality of segment data fields SF1-SF8. A segment identifier SGID is stored in a first segment data field SF1. The data segment identifier SGID uniquely identifies each segment SG and may be serve as a street element identifier that identifies the street segment in which the image data DA-DX contained within the instant segment SG was acquired by the camera 12. A second segment data field SF2 contains a first endpoint document DE1 and a plurality of segment identifiers ID1. The plurality of segment identifiers ID1 are used by the client system 36 to identify other segments SG that include documents D having GPS data D2 that specify geographic locations proximate to the geographic location identified by the GPS data D2 of the first endpoint DE1.

The third through seventh segment data fields SF3-SF7 each contain a single document D, wherein the documents DA-DX are sequentially ordered in order from a first document DA to a last document DX. For example, the first endpoint document might include GPS data D2 derived when the first system 2 was at a first location L1, and a following data field SF3 might contain a document DA that includes GPS data D2 derived when the first system 2 was located at a second location L2. Another following data field SF4 might contain a document DB that includes GPS data D2 derived when the first system 2 was located at a third location L3, and yet another following data field SF5 might contain a document DC that includes GPS data D2 derived when the first system was located at a fourth location L4.

The documents DA-DX are ordered according to the GPS data D2 stored in each document DA-DX, wherein the document DA-DX having a GPS data D2 representing a geographic location most proximate to the geographic location indicated by the GPS data D2 of the first endpoint DE1 is stored in the third segment data field SF3. The remaining documents DB-DD of the segment SG are sequentially ordered within the segment SG according in order of proximate-to-distal location of their GPS data D2 location indications to the GPS data D2 location indication of the first endpoint DE1. An eighth segment data field SF8 contains a second endpoint document DE2 and a second plurality of segment identifiers ID2. The second plurality of segment identifiers ID2 are used by the client system 36 to identify other segments SG that include documents D having GPS data D2 that specify geographic locations proximate to the geographic location identified by the GPS data D2 of the second endpoint DE2.

The street video may be composed of image data P provided by a plurality of segments SG. The segments SG may be joined together to provide associated image data P captured by the camera 12 from the actual streets with which the documents D are associated by GPS data D2. One or more end points DE1 & DE2 of each segment may correspond to an actual street intersection. The organization of the documents D into segments. SG facilitates the provision to a user of the client system 26 a visual presentation of the image data P that simulates walking along, or driving a vehicle, to arrive at intersection, turn onto another street, and then walk or drive onto other streets.

As discussed above in reference to the generation and informational content of each document D, each document DE1, DE2, DA-DX contains 360 degree panoramic image data P and a GPS data D2 that corresponds to a GPS coordinate on the street S as illustrated below.

The GPS coordinate of each 360-degree panoramic image is embedded into the metadata of the actual image. So as an image is viewed, the geographic location that it represents can be determined allowing the image to be associated with information relative to that specific location. This is known as geo-spatial referencing of information and in particular allows for geo-spatial advertising to be conducted simultaneously as the viewer “virtually” drives a street.

Besides referencing information or advertising relative to the geocoded 360 panoramic image P, the documents D can be referenced by other GIS based systems. For example, an external computer system 40 (as per FIG. 3) coupled with the electronic communications network 38 could query all the images P associated with properties for sale in a geographic area. That system could then plot the locations of 360 panoramic images P and allows viewers to see the panoramic view P of the property list for sale.

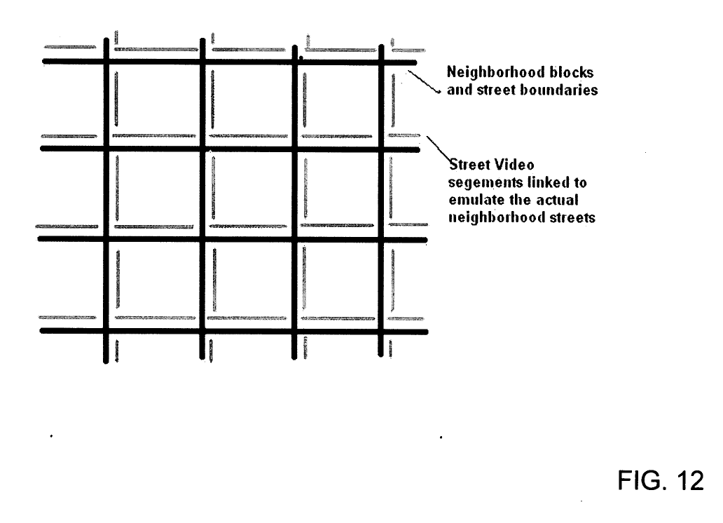

Referring now generally to the Figures and particularly to FIG. 12, FIG. 12 is a schematic diagram that illustrates that segments SG may be organized to present image data P associated with a particular street, section of a street, or a neighborhood.

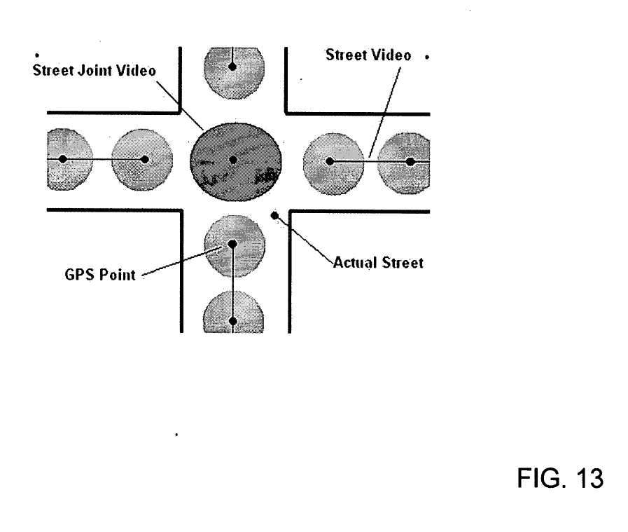

Referring now generally to the Figures and particularly to FIG. 13, FIG. 13 illustrates the utility of providing a segment SG that has an endpoint DE1 or DE2 that is associated by means of a plurality of segment identifiers ID1 or ID2 with other segments SG that have contain a document D having a GPS data D2 that is proximate the GPS data 2 of the instant endpoint document DE1 or DE2. The association of segments SG by the proximity indications of the GPS data D2 comprised within endpoint documents DE1 or DE 2 enables the client system 36 to more efficiently manage the processing of image data P to present a more immersive experience of viewing the rendered image data P in a real-time or near real-time simulation. Rather than uploading or downloading a large volume of documents D as a unified library, the client system 36 can upload and/or download segments SG that are more likely to be rendered on the basis of the association of segments SG by segment identifiers SGID that are stored in each segment SG.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

We claim:

1. In an information technology system having a 360 digital degree camera, a method for collecting photographic data, the method comprising:
a. Collecting a plurality of individual digitized 360 degree images;
b. Associating a geographic location data with each digitized image;
c. Storing the plurality of digitized 360-degree images and associated geographic location data in an accessible data structure.

2. The method of claim 1, wherein the data structure is stored within a unified database.

3. The method of claim 2, wherein the unified database is stored in a unitary memory device.

4. The method of claim 1, wherein the data structure is distributed within an electronic communications network.

5. The method of claim 1, wherein the data structure is distributed at least partially within the Internet.

6. The method of claim 1, wherein the geographic location data comprises GPS data.

7. The method of claim 6, wherein the information technology system further includes an inertial change detection device, and the inertial change detection device output is integrated with the GPS data to estimate at least one geographic location data.

8. The method of claim 1, wherein at least two of the plurality of digitized 360-degree images are captured within 2 meters of at least one other digitized 360-degree image.

9. The method of claim 1, wherein at least two of the plurality of digitized 360 degree images are captured within 1 seconds of the capturing of at least one other digitized 360 degree image.

10. The method of claim 1, wherein at least one visual image is integrated within at least one digitized 360 degree image for simultaneous presentation with the at least one digitized 360 degree image.

11. The method of claim 10, wherein the at least one visual image contains information content related to a geographic location data associated with the at least one digitized 360 degree image.

12. The method of claim 10, wherein the at least one visual image contains information content describing a real property related to a geographic location data associated with the at least one digitized 360 degree image.

13. The method of claim 10, wherein the at least one visual image comprises an advertisement.

14. The method of claim 13, wherein the advertisement relates to a real property transaction service.

15. The method of claim 1, wherein the geographic location data is associated with a postal address.

16. A device for capturing photographic images of real property, the device comprising:
a. a 360 degree digital camera;
b. a computational engine, the computational engine coupled with the 360 degree digital camera and for receiving digitized image documents from the 360 degree digital camera; and
c. a motorized platform, the motorized platform for transporting the 360 degree camera and the computational engine while the 360 degree digital camera generates digitized image documents

17. The device of claim 16, wherein the device further comprises a GPS receiver, the GPS receiver coupled with the computational engine and the GPS receiver for providing GPS data associated with each digitized image document.

18. The device of claim 17, wherein the device further comprises an inertial change detection device, the inertial change detection device for providing data describing inertial change of the device substantially simultaneous with a time of generation of at least one digitized image document.

19. The device of claim 16, the device further comprising a light source, the light source coupled with the 360 degree digital camera and the light source configured to increase the quality of digitized image documents generated by the 360 degree digital camera.

20. The device of claim 16, wherein the 360 degree camera is configured to generate 360 degree by 180 degree digitized images.

21. A data structure, the data structure comprising:
a. A plurality of 360 degree image documents, and each image document associated with a GPS data; and
b. An endpoint document, each endpoint document associated with a GPS data and each endpoint document comprising a 360 degree image document and at least one identifier of at least one additional data structure, whereby the data structure is associated with the at least one additional data structure.

22. The data structure of claim 21, wherein the data structure further comprises a video data and a street element identifier, wherein the video segment records a portion of a street that is associated with the street element identifier.
